(19) United States
(12) Patent Application Publication
(10) Pub. No.: US 2016/0326802 A1
(43) Pub. Date: Nov. 10, 2016

(54) ACCESS SYSTEM FOR MACHINE

(71) Applicant: Caterpillar Inc., Peoria, IL (US)

(72) Inventor: Andrew F. Lawson, Milwaukee, WI (US)

(73) Assignee: Caterpillar Inc., Peoria, IL (US)

(21) Appl. No.: 15/214,001

(22) Filed: Jul. 19, 2016

(51) Int. Cl. E06C 5/06; E02F 9/08

(52) U.S. Cl. CPC E06C 5/06; E02F 9/0833

(57) ABSTRACT

The disclosure relates to an access system for a machine. The access system includes an access stairway having a first end portion connected to a platform of the machine and a second end portion opposite to the first end portion. The access system further includes a hydraulic assembly located on the platform of the machine, and operably coupled to the access stairway. The hydraulic assembly is adapted to move the access stairway between a first position and a second position about an axis of rotation. The second end portion of the access stairway is proximal to a ground surface in the first position and distal from the ground surface in the second position. The access system further includes a stopper adapted to restrict movement of the access stairway when the second end portion of the access stairway is proximal to the ground surface.

### TECHNICAL FIELD

The present disclosure relates to access systems for machines, and more specifically relates to a powered access system for a machine.

### BACKGROUND

Machines, such as a hydraulic mining shovel, a large mining truck, and other large machines includes operator cabin positioned at an elevated position from a ground surface. Due to such positioning of the operator cabin, typically, access stairway or ladders may be provided on either side of the machine in order to assist the operator to reach the operator cabin, Further, the access stairway may often extend in a direction perpendicular to the sides of the machine, Such positioning of the stairway on the either side of the machine may consume additional space, and the access stairway therefore may be an obstacle for other machines operating in the vicinity of the machine. Further, the stairway may also come in contact with the ground surface, thereby causing safety issues within a worksite.

Japanese Publication Number 2008240278, hereinafter referred to as the '278 publication, describes a construction machinery that can restrain a lifting and lowering device from being damaged due to settling of a grounding surface thereof, and which facilitates ascent/descent between a chassis and the ground by using the lifting and lowering device. A base-end side of a front link and a base-end side of a rear link are mounted in a vertically rotatable manner on the side of a lower end of a second ladder portion constituting the lifting and lowering device. A connection link is rotatably mounted on the leading-end side of the front link and the leading-end side of the rear link, so that the connection link serving as a scaffold for an operator can be arranged on the downside with respect to a lowermost step of the second ladder portion. Thus, the operator can use the connection link, as a first foothold, of an auxiliary lifting and lowering device arranged on the downside with respect to the lowermost step, and can be quickly and easily lifted and lowered between a revolving super structure of a hydraulic excavator and the ground, by using the auxiliary lifting and lowering device and the lifting and lowering device as the footholds. However, the '278 publication fails to disclose an arrangement that is operable and within safety standards.

### SUMMARY OF THE DISCLOSURE

In one aspect of the present disclosure, an access system for a machine is provided. The access system includes an access stairway having a first end portion connected to a platform of the machine and a second end portion opposite to the first end portion. The access system further includes a hydraulic assembly located on the platform of the machine, and operably coupled to the access stairway. The hydraulic assembly is adapted to move the access stairway between a first position and a second position about an axis of rotation. The second end portion of the access stairway is proximal to a ground surface in the first position and distal from the ground surface in the second position. The access system further includes a stopper provided at the first end portion of the access stairway. The stopper is adapted to restrict movement of the access stairway when the second end portion of the access stairway is proximal to the ground surface.

Other features and aspects of this disclosure will be apparent from the following description and the accompanying drawings.

### BRIEF DESCRIPTION OF THE DRAWINGS

FIG. 1 is a side view of a machine with an access system;

FIG. 2 is a perspective view of the access system of FIG. 1;

FIG. 3 is a perspective view of the machine showing coupling between a hydraulic assembly and a frame of the machine;

FIG. 4 is a bottom perspective view of a portion of the of the machine; and

FIG. 5 is a side view of the access stairway in a second position.

### DETAILED DESCRIPTION

Reference will now he made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in singular may also be construed to relate to the plural and vice-versa without limiting the scope of the disclosure to the exact number or type of such elements unless set forth explicitly in the appended claim.

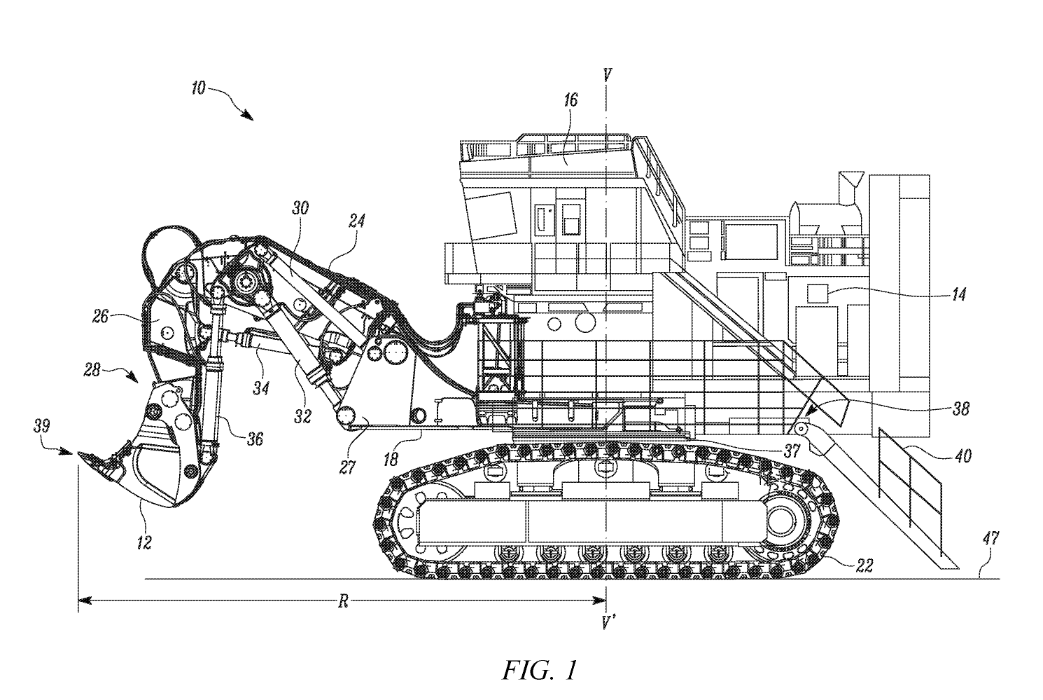

Referring to FIG. 1, a side view of an exemplary machine 10 is shown. The machine 10, disclosed herein, is a hydraulic mining shovel embodied in form of a tracked vehicle having an excavating bucket 12. Although embodiments of the present disclosure are disclosed in conjunction with the hydraulic mining shovel, it will be appreciated that systems and methods disclosed herein can be similarly applied to other types of machines known in the art without deviating from the spirit of the present disclosure. The machine 10 further includes a power source 14 and an operator cabin 16 that is rigidly mounted on a platform 18. The power source 14 may be a fuel-based engine that powers the machine 10 by combustion of natural resources, such as gasoline, liquid natural gas, or other petroleum products. However, in alternative embodiments, the present disclosure may he equally implemented by way of using an electric motor in lieu of the engine, or a hybrid system that allows use of an engine and an electric motor for performing functions associated with the machine 10. Further, the machine 10 also includes a pair of tracks 22 that are used for propelling the machine 10 (only one track 22 visible in the view illustrated in FIG. 1). The operator cabin 16 may house various controls of the machine 10. The various controls provided in the operator cabin 16 may include, but not limited to, steering control (not shown) for guiding the machine 10, air conditioning control (not shown), and/or any other control known in the art. Moreover, the operator cabin 16 includes control implements (not shown) that are operable for controlling a working of the machine 10.

Further, as shown in FIG. 1, the machine 10 may include a boom 24, and a stick 26 that are pivotally coupled in sequence to a frame 27. A distal end 28 of the stick 26 is also coupled to the bucket 12 of the machine 10. The boom 24 and the stick 26 may operate the bucket 12 for executing operations such as loading and/or unloading of material from a work site (not shown). The boom 24 may be raised and lowered by a pair of first hydraulic actuators 30, 32. The stick 26 may be moved toward and outward with respect to the operator cabin 16 by a second hydraulic actuator 34. A third hydraulic actuator 36 may be used to curl and uncurl the bucket 12 relative to the stick 26. The platform 18 may be rotated about an axis of rotation V-V of the machine 10, with respect to the pair of tracks 22, by a fourth hydraulic actuator 37, such as a hydraulic motor. Further, a peripheral edge 39 of the machine 10 traces a circular path while the machine 10 rotates about the axis of rotation V-V′. As such, the circular path traversed by the machine 10 defines a radius of rotation ‘R’ of the machine 10.

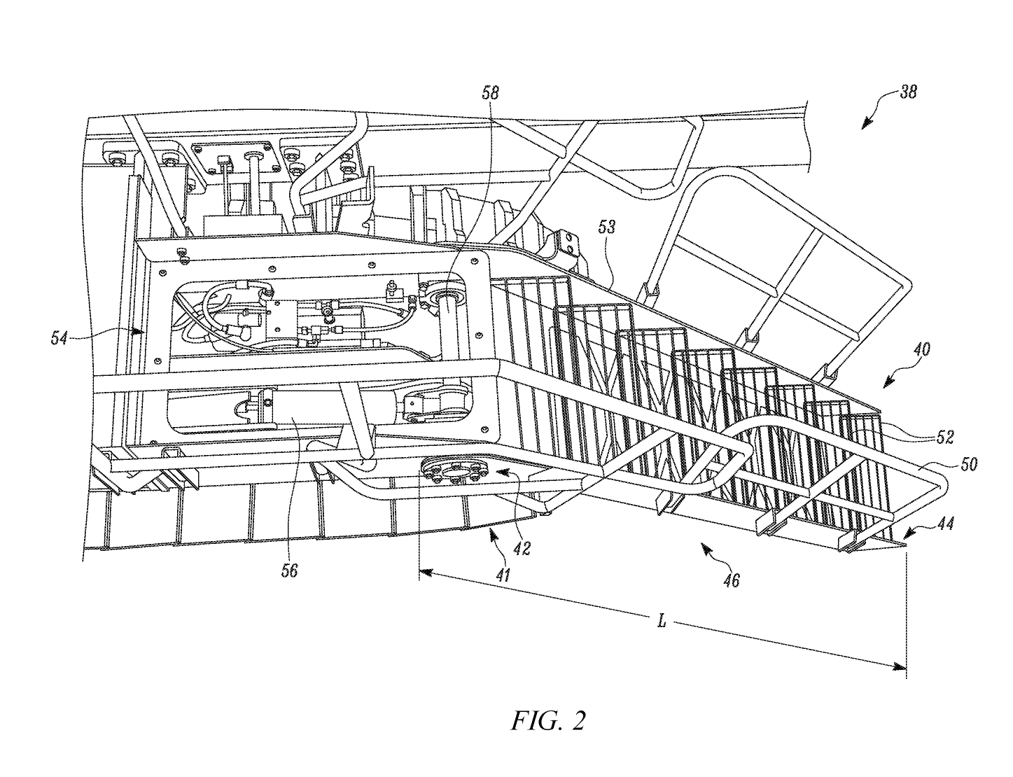

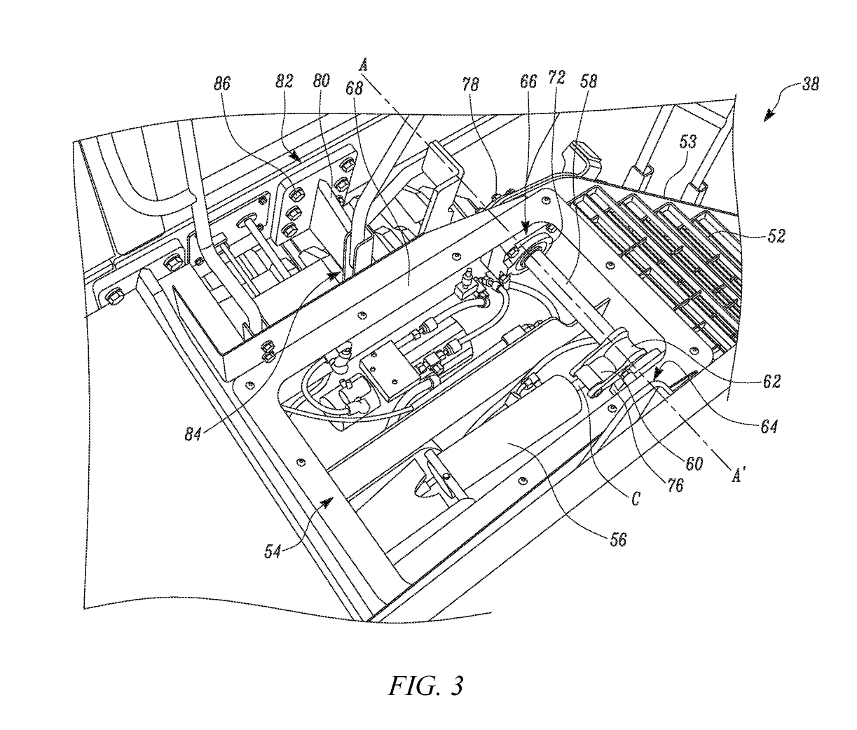

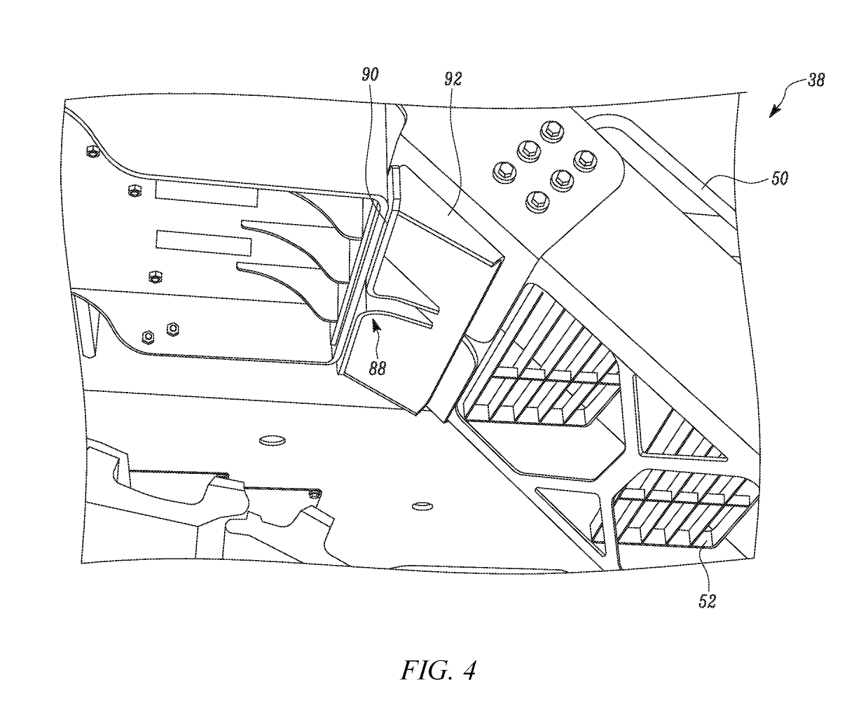

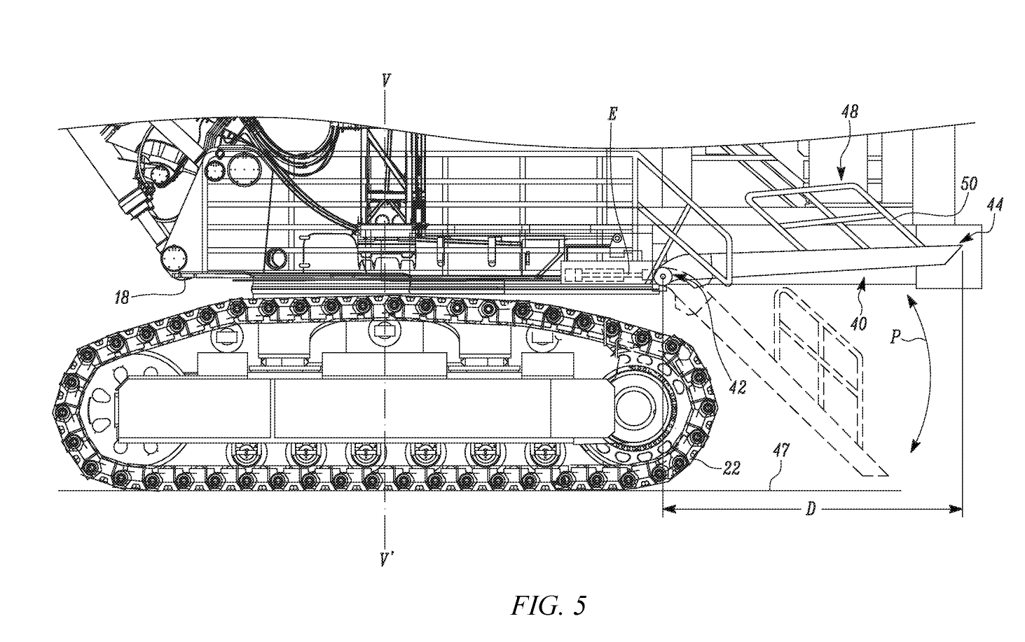

Further, an access system 38 may be provided for the machine 10 to enable access to the machine 10. The access system 38 may extend from the platform 18, providing access to the platform 18 and/or the operator cabin 16. For example, the access system 38 operates an access stairway 40 to allow an operator to access the machine 10. The manner in which the access system 38 provides access to the machine 10 is explained in detail with respect to FIG. 2, FIG. 3, FIG. 4, and FIG. 5.

Referring FIG. 2, a perspective view of the access system 38 of FIG. 1 is shown. As described earlier, the access system 38 includes the access stairway 40 having a first end portion 42 and a second end portion 44 opposite to the first end portion 42. The first end portion 42 of the access stairway 40 is coupled to the platform 18 of the machine 10. More specifically, the first end portion 42 of the access stairway 40 is coupled to a rear end portion 41 of the platform 18 of the machine 10. The access system 38 provides the operator or a service technician access to the platform 18. In an embodiment, the access stairway 40 may be a powered access stairway movable between a first position 46 and at a second position 48 (as shown in FIG. 5). The second end portion 44 of the access stairway 40 is proximal to a ground surface 47 (as shown in FIG. 1) in the first position 46 of the access stairway 40. The second end portion 44 of the access stairway 40 is distal to the ground surface 47 in the second position 48 of the access stairway 40. Although, the access stairway 40 is embodied as the powered access stairway, alternatively the access stairway 40 may include, for example, but not limited to, ladders, ramps, and stair steps.

Further, the access stairway 40 may include a handrail 50 adapted to be attached with the access stairway 40. The handrail 50 provides support to the operator and prevents the operator from falling. The access stairway 40 further includes a plurality of step portions 52 along a length ‘L’ of the access stairway 40. Each of the plurality of step portions 52 is at an equal distance along the length ‘L’ of the access stairway 40. The access stairway 40 further includes a support member 53 located on either side of the plurality of step portions 52. The support member 53 provides support to each of the plurality of step portions 52 of the access stairway 40.

The access system 38 further includes a hydraulic assembly 54 located on the platform 18 of the machine 10. More specifically, the hydraulic assembly 54 is located proximal to the rear end portion 41 of the platform 18. The hydraulic assembly 54 is coupled to the access stairway 40, and facilitates movement of the access stairway 40 between the first position 46 and the second position 48. In particular, the hydraulic assembly 54 is coupled to the first end portion 42 of the access stairway 40. The manner in which the hydraulic assembly 54 enables movement of the access stairway 40 between the first position 46 to the second position 48 is explained in detail with respect to FIG, 3.

Referring to FIG. 3, a perspective view of the machine 10 showing coupling between the hydraulic assembly 54 and the frame 27 of the machine 10 is shown. The hydraulic assembly 54 includes a hydraulic actuator 56. The hydraulic actuator 56 operates between an expanded condition ‘E’ (as shown in FIG. 5) and a contracted condition ‘C’. The hydraulic assembly 54 further includes a connecting member 58 coupled to the hydraulic actuator 56. The connecting member 58 further includes a first end 64 and a second end 66 distal to the first end 64. The connecting member 58 is coupled to the hydraulic actuator 56 in a manner, such that an actuation of the hydraulic actuator 56 between the contracted condition ‘C’ and the expanded condition ‘E’ allows rotational movement of the connecting member 58. A housing 68 of the hydraulic assembly 54 includes a first hole (not shown) in a first huh portion 72 and a second hole (not shown) in a second hub portion 76. The first hole and the second hole allows positioning of the connecting member 58 with respect to the support member 53 of the access stairway 40. Owing to such positioning of the connecting member 58 with the support member 53, the hydraulic assembly 54 is coupled to the support member 53 of the access stairway 40 via multiple fastening members 78. In an example, the multiple fastening members 78 used for coupling the hydraulic assembly 54 with the support member 53 may be a bolt.

For the purpose of achieving transfer of force between the hydraulic actuator 56 and the connecting member 58, coupling joints are employed, as shown. In an example, one end of a piston (not shown) of the hydraulic actuator 56 may he coupled to a fork joint 60 of the connecting member 58. The fork joint 60 may include a body portion 62 having a bore (not shown) therein to coaxially engage with the connecting member 58. The fork joint 60 is provided proximal to the first end 64 of the connecting member 58. When the hydraulic actuator 56 is in the expanded condition ‘E’, the forward movement of the hydraulic actuator 56 causes rotational movement of the connecting member 58 about an axis of rotation A-A′ defined by the connecting member 58. Further, due to the rotational movement of the connecting member 58, the second end portion 44 is displaced away from the ground surface 47 (as shown in FIG. 1). The hydraulic assembly 54 moves the access stairway 40 between the first position 46 and the second position 48 about the axis of rotation A-A′ defined by the connecting member 58.

The machine 10 further includes a mounting member 80 having a first end 82 and a second end 84. The first end 82 is coupled to the frame 27 of the machine 10 via multiple fastening members 86. Further, the second end 84 of the mounting member 80 is coupled to the hydraulic assembly 54 via multiple fastening members (not shown). The mounting member 80 provides a rigid coupling between the hydraulic assembly 54 and the frame 27 of the machine 10.

Referring to FIG. 4, a bottom perspective view of a stopper 88 coupled to the access stairway 40 is shown. The stopper 88 is provided at the first end portion 42 of the access stairway 40. More specifically, the stopper 88 is coupled to the rear end portion 41 of the platform 18. The stopper 88 is adapted to restrict movement of the access stairway 40 when the second end portion 44 of the access stairway 40 is proximal to the ground surface 47. In the illustrated embodiment, the stopper 88 is located beneath the access stairway 40. In an example, the stopper 88 may be used for holding the access stairway 40 in the first position 46 in the contracted condition ‘C’ of the hydraulic actuator 56. The stopper 88 includes a first portion 90 and a second portion 92. The first portion 90 is coupled to the platform 18 of the machine 10. In an example, the first portion 90 may be coupled to the platform 18 via welding. Further, the access stairway 40 rests upon the second portion 92 of the stopper 8 the first position 46.

Referring to FIG. 5, a side view of the access stairway 40 in the second position 48 is shown. Specifically, FIG. 5 shows the access stairway 40 being actuated to the second position 48 from the first position 46. Such actuation of the access stairway 40 is possible upon the operator reaching the operator cabin 16 when the access stairway 40 is in the first position 46. Further, upon actuation of control levers in the operator cabin 16, the hydraulic actuator 56 may actuate the access stairway 40 from the first position 46 to the second position 48. On being actuated, the piston of the hydraulic actuator 56 moves from the contracted condition ‘C’ to the expanded condition ‘E’. Owing to the coupling between the piston and the connecting member 58, the movement of the piston allows rotation of the connecting member 58. Furthermore, due to the coupling between the support member 53 and the connecting member 58, the second end portion 44 of the access stairway 40 is displaced from the ground surface 47 due to the rotation of the connecting member 58. Subsequent movement of the piston from the contracted condition ‘C’ to the expanded condition ‘E’ causes further rotation of the connecting member 58, thereby allowing the second end portion 44 of the access stairway 40 to trace an arcuate path ‘P’ as shown in FIG. 5. Further, the peripheral edge 39 of the machine traces a circular path while the machine 10 rotates about the axis of rotation V-V′. As such, the circular path traversed by the machine 10 defines a radius of rotation ‘R’ of the machine 10. Owing to the actuation of the access stairway 40 by the hydraulic assembly 54, a distance ‘D’ of the access stairway 40 defined between the second end portion 44 and the axis of rotation V-V′ of the machine 10 is less than the radius of rotation ‘R’ of the machine 10.

### INDUSTRIAL APPLICABILITY

The present disclosure relates to the access system 38 for the machine 10. The access system 38 is provided for the machine 10 to enable access to the machine 10. The access system 38 may extend from the platform 18, providing access to the platform 18 and/or the operator cabin 16, With the deployment of the access stairway 40 at the rear end portion 41 of the platform 18, easy access to the operator of the machine 10 is ensured. Further, due to angular dispositioning of the access stairway 40 with respect to the platform 18, the access stairway 40 would not be an obstacle for other machines operating in the vicinity of the machine 10. In addition, the access stairway 40 can be selectively operated by the operator.

Also, due to the angular disposition and the length the access stairway 40, the distance ‘D’ of the second end portion 44 of the access stairway 40 from the axis of rotation V-V′ is well within the radius of rotation ‘R’ of the machine 10. In addition, the second end portion 44 of the access stairway 40 is located well above the ground surface 47, thereby eliminating possibility of contact between the access stairway 40 and the ground surface 47. As such, the actuation of the access stairway 40 of the present disclosure ensures undisturbed operation of the machine 10, irrespective of the terrain of the ground surface 47.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An access system for a machine, the access system comprising:
an access stairway having a first end portion connected to a platform of the machine and a second end portion opposite to the first end portion;
a hydraulic assembly located on the platform of the machine, and operably coupled to the access stairway, the hydraulic assembly adapted to move the access stairway between a first position and a second position about an axis of rotation, the second end portion of the access stairway being proximal to a ground surface in the first position and distal from the ground surface in the second position; and
a stopper provided at the first end portion of the access stairway, the stopper adapted to restrict movement of the access stairway when the second end portion of the access stairway is proximal to the ground surface.

2. The access system of claim 1, wherein the first end portion of the access stairway is connected to a rear end portion of the platform of the machine, and a distance of the second end portion of the access stairway from an axis of rotation of the machine is less than a radius of rotation of the machine.
